(19) United States
(12) Patent Application Publication
(10) Pub. No.: US 2026/0273641 A1
(43) Pub. Date: Sep. 17, 2026

(54) HEATER CARTRIDGE AND HOT AIR DEVICE

(71) Applicant: HAKKO CORPORATION, Osaka (JP)

(72) Inventor: Hisao NEMOTO, Osaka (JP)

(21) Appl. No.: 19/542,128

(22) Filed: Feb. 17, 2026

(30) Foreign Application Priority Data
Mar. 14, 2025 (JP) 2025-41571

(51) Int. Cl. B23K 3/047

(52) U.S. Cl. CPC B23K 3/047

(57) ABSTRACT

A heater cartridge is disclosed including a first pipe having a connector to be coupled to an electrical contact provided on the handle, a heater electrically connected to the connector, a second pipe having an inner space for housing the heater and a front end which is opened, a large diameter portion positioned between the first pipe and the second pipe, the large diameter portion having an external shape with diameter larger than the outer diameters of both the first pipe and the second pipe. The large diameter portion is formed with a connection-through space communicating with the inner space of the second pipe, and with an introduction passage mutually communicating with the outside of the large diameter portion and the connection-through space. When the heater cartridge is placed within the insertion hole of the handle, gas supplied into the insertion hole flows into the connection-through space via the introduction passage.

### CROSS-REFERENCE

The present application claims the benefit of and priority to Japanese Patent Application No. 2025-41571, filed Mar. 14, 2025. The entire contents of which are herein incorporated by reference in its entirety for all purposes.

### Technical Field

The present invention relates to a heater cartridge and a hot air device.

### Background Art

Conventionally, a hot air device that blows hot air to melt solder is known for use when soldering electronic components onto a substrate or removing electronic components from a substrate. The following website by Hakko Corporation features such hot air devices. The hot air devices presented on this website include a handle and a heater cartridge that is inserted to the handle. The heater cartridge includes a heater-side pipe containing the heater and a plug-side pipe with a plug which interfaces with the electrical contacts provided in the handle. Opening for introducing gas is formed on the plug-side pipe, and gas supplied to the handle flows into the heater cartridge through this opening. The gas is heated by the heater and then blows out from the front end of the heater-side pipe.

### NON-PATENT LITERATURE

[Non-Patent Literature 1] Hakko Corporation Product Information: ‘Desoldering & Rework-Related/Hot Air FM-2029’, Single Hot Air (For use with Multi Rework Station FM-206 Only) N4 Nozzle Series <URL>https://www.hakko.com/japan/products/hakko_fm2029.html

### SUMMARY OF THE INVENTION

### Problem to be Solved by the Invention

In recent years, with the miniaturization of electronic components, it has become necessary to reduce the diameter of the heater-side pipe that blows out gas. This is because a thick heater-side pipe may obstruct operations performed under a microscope. On the other hand, when the heater cartridge is made thinner, the plug-side pipe will also become thinner making it difficult to employ a large opening for gas inflow. In this case, there is a risk that the flow rate of gas blowing out may decrease due to an increase in gas inflow resistance.

The object of the present invention is to provide a heater cartridge in which the increase in gas inflow resistance is suppressed, even when the pipe for exhausting/blowing-out gas is narrow.

### Means for Solving the Problems

The heater cartridge according to one aspect of the present invention is a heater cartridge which is used to be inserted to an insertion hole provided in a handle, comprising a first pipe having a connector configured to be coupled to an electrical contact provided in the handle, a heater electrically connected to the connector, a second pipe with an opening at the front end having an inner space for housing the heater, and a large diameter portion positioned between the first pipe and the second pipe, having an external shape with a diameter larger than the outer diameter of the first pipe and the second pipe. At the large diameter portion, a connection-through space that communicates with the inner space of the second pipe, and an introduction passage that communicates between the outside of the large diameter portion and the connection-through space are formed. When the heater cartridge is placed in the insertion hole, the gas supplied in the insertion hole may enter the connection-through space via the introduction passage.

When gas is supplied to the handle while said heater cartridge is inserted in the insertion hole of the handle, the gas is introduced, from the insertion hole in the handle, into the connection-through space of the large diameter portion via the introduction passage formed in the large diameter portion of the heater cartridge. This gas flows into the inner space of the second pipe and is heated by the heater. The heated gas flows out from the second pipe through the opening at the front end of the second pipe. The introduction passage which introduces gas via the insertion hole of the handle is provided at the large diameter portion, having an external shape larger than the outer diameters of both the first pipe and the second pipe. Accordingly, it is possible to prevent the introduction passage from becoming narrower, thereby suppressing increase in gas inflow resistance. That is, if an opening for introducing gas is formed on the first pipe having the connector, and if the first pipe is formed with narrow diameter, the opening will consequently be small, resulting in increased gas inflow resistance. In contrast, if the introduction passage is formed at the large diameter portion, it will be able to increase the opening area of the introduction passage, thereby suppressing the increase of gas inflow resistance. Moreover, since it is possible to suppress reduced strength of the first pipe, it may also prevent deterioration of attachability/detachability of the heater cartridge to the handle.

Said large diameter portion may comprise a body formed with said introduction passage, a first holding portion holding said first pipe, said first holding portion integrally formed with said body, and a second holding portion holding said second pipe, said second holding portion integrally formed with said body.

In this aspect, the first pipe may be stably hold, and the second pipe may be stably hold.

Said introduction passage may open to an inner peripheral surface facing the connection-through space between said first holding portion and said second holding portion. In this aspect, while preventing the first pipe and the second pipe from obstructing the inflow of gas into the connection-through space, it is possible to stably hold the first pipe and the second pipe.

Said introduction passage may penetrate through said large diameter portion between an outer surface of said large diameter portion and an inner peripheral surface of said large diameter portion facing the connection-through space.

In this aspect, gas can be smoothly introduced from the insertion hole of the handle into the connection-through space of the large diameter portion.

Said introduction passage may include a plurality of flow paths, placed at intervals around a circumferential direction of said large diameter portion. In this aspect, since the flow paths are divided into multiple paths, it is possible to increase the opening area while maintaining the strength of the large diameter portion.

Said introduction passage may be provided at a tubular body positioned between said first pipe and said second pipe of said large diameter portion. In this case, the thickness of said body may be greater than that of said first pipe.

In this aspect, even if the introduction passage with a larger opening area is formed at the body of the large diameter portion, the strength of the cartridge for attaching/detaching to the handle can be maintained. Accordingly, while ensuring attachment/detachment of the cartridge, it is possible to further reduce the gas inflow resistance introduced through the introduction passage.

A hot air device according to one aspect of the present invention comprises, said heater cartridge, a handle provided with an insertion hole where said heater cartridge is inserted. Said handle supports said connector of said heater cartridge inserted to said insertion hole, and supports said large diameter portion at a position away from said connector.

In said hot air device, the handle may securely support the heater cartridge.

In said hot air device, said large diameter portion may include a tapered portion contacting said handle. In this aspect, it is easier to position the large diameter portion with respect to the handle in the longitudinal direction.

A hot air device according to one aspect of the present invention comprises, said heater cartridge, a handle provided with an insertion hole where said heater cartridge is inserted. Said large diameter portion contacts said handle at a portion besides said introduction passage.

In the hot air device, the large diameter portion may function not only as a portion for forming the introduction passage, but also as a portion for positioning the heater cartridge with respect to the handle in the longitudinal direction.

### Effect of the Invention

As described above, according to the present invention, even if the pipe for gas outflow is narrow, it is possible to provide a heater cartridge where the increase in gas inflow resistance is suppressed.

### BRIEF DESCRIPTION OF THE DRAWINGS

FIG. 1 is an external view of a heater cartridge according to the first embodiment.

FIG. 2 is a cross-sectional view of a hot air device in the state where the heater cartridge is attached to the handle.

FIG. 3 is a cross-sectional view, cross-sectioned at a portion other than the introduction passage of the heater cartridge.

FIG. 4 is a cross-sectional view, cross-sectioned at the introduction passage of the heater cartridge.

FIG. 5(a) is a perspective view of the heater cartridge, partially showing the vicinity of the large diameter portion. FIG. 5 (b) is a cross-sectional view of the heater cartridge, partially showing the vicinity of the large diameter portion.

FIG. 6 is a partial perspective view of the heater cartridge according to a modified embodiment.

FIG. 7 is a partial perspective view of the heater cartridge according to a modified embodiment.

FIG. 8(a) is a partial perspective view of the heater cartridge according to the second embodiment. FIG. 8(b) is a partial cross-sectional view of the heater cartridge according to the second embodiment.

FIG. 9 is a partial perspective view of the heater cartridge according to the second embodiment.

FIG. 10 is a view illustrating the heater cartridge according to a modified embodiment.

FIG. 11 is a view illustrating the heater cartridge according to a modified embodiment.

### EMBODIMENT OF THE INVENTION

The embodiments of the present invention will be described in detail below with reference to the accompanying drawings.

### First Embodiment

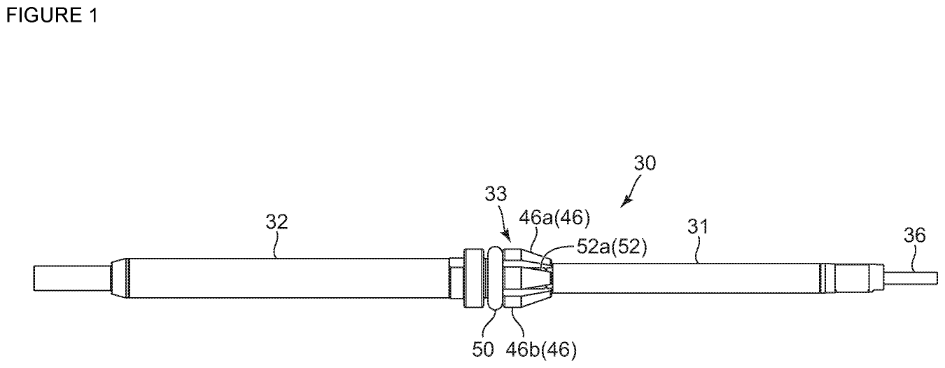

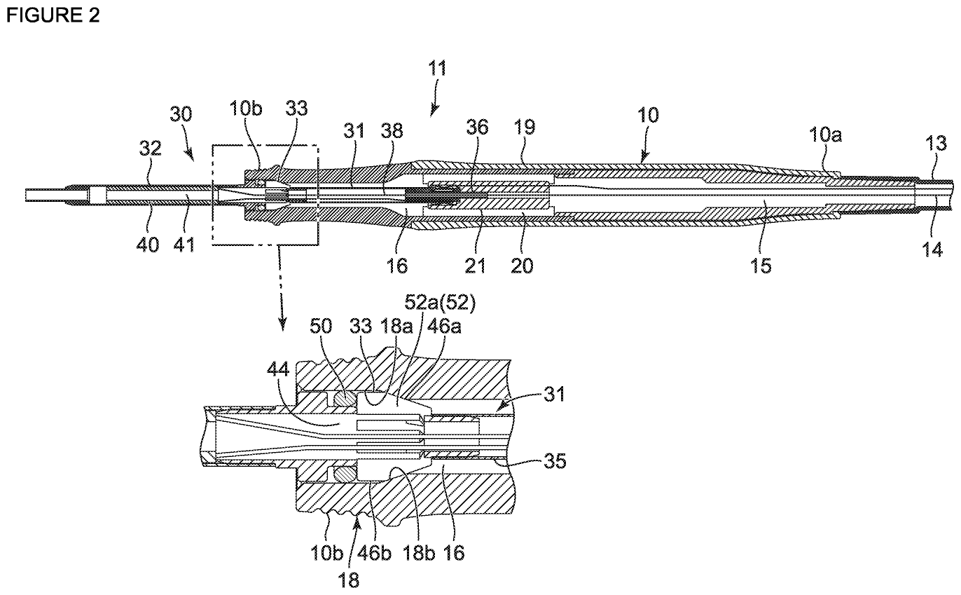

As shown in FIG. 1, the heater cartridge 30 according to the embodiment is provided with a connector 36 at the proximal end and an opening at the front end. As shown in FIG. 2, the heater cartridge 30 is used by attaching it to the handle 10. That is, by attaching the heater cartridge 30 to the handle 10, it becomes a hot air device 11 for blowing out hot gas at a temperature sufficient to melt solder.

The handle 10 is made of resin, may be held by hand, and is formed in an elongated shape in one direction. At one end portion (proximal portion 10a) in the longitudinal direction of the handle 10, a tubular cord 13 is connected.

Cord 13 internally contains a power line 14 that connects to a controller (not shown) and also conveys gas supplied from the controller. The controller is provided with a control unit to adjust the power output of the heater 40 (described later) installed in the heater cartridge 30, and a pump or blower (not shown) for sending gas to the heater cartridge 30. The gas may be an inert gas such as nitrogen, or air, among others.

At the proximal portion 10a of the handle 10, a flow-through hole 15 extending in the longitudinal direction of the handle 10 is open at one end portion. Additionally, at the distal portion 10b of the handle 10, an insertion hole 16 extending in the longitudinal direction of the handle 10 is open at one end portion. The heater cartridge 30 may be inserted into the insertion hole 16. In this embodiment, a through hole penetrating the handle 10 in the longitudinal direction is formed by the communication between the flow-through hole 15 and the insertion hole 16.

The internal space of the cord 13 communicates with the flow-through hole 15 of the handle 10. Accordingly, gas flowing inside the cord 13 enters the flow-through hole 15 of the handle 10. Further, the power line 14 extends out from the internal space of the cord 13 and is inserted into the flow-through hole 15 inside the handle 10.

The handle 10 includes a distal support 18 which supports the large diameter portion 33 (described later) of the heater cartridge 30, and a proximal support 19 which supports the connector 36 provided on the heater cartridge 30. Accordingly, the heater cartridge 30 is supported by the handle 10 at two positions spaced away from each other along the longitudinal direction of the handle 10.

The proximal support 19 is placed as to delimit the flow-through hole 15 and the insertion hole 16 in the longitudinal direction of the handle 10. However, a flow-through space 20 is formed in the proximal support 19 to allow communication between the flow-through hole 15 and the insertion hole 16. The flow-through space 20 enables the flow-through hole 15 and the insertion hole 16 to communicate with each other partially in the circumferential direction of the flow-through hole 15 and the insertion hole 16. Accordingly, while the heater cartridge 30 is supported by the proximal support 19, the gas flow from the internal space of the cord 13 into the flow-through hole 15 may flow into the insertion hole 16 via the flow-through space 20.

An electrical contact 21 for coupling to the connector 36 is placed at the proximal support 19. Therefore, when the heater cartridge 30 is attached to the handle 10, the connector 36 of the heater cartridge 30 is coupled to the electrical contact 21 of the handle 10. As a result, power may be supplied to the heater cartridge 30. The proximal support 19 may support the heater cartridge 30 in the state the connector 36 is coupled to the electrical contact 21.

The distal support 18 is positioned away from the proximal support 19 towards the distal portion 10b of the handle 10. The distal support 18 includes a parallel inner surface 18a and a slanted inner surface 18b adjacent to the parallel inner surface 18a. The parallel inner surface 18a is arranged at a position to face the outer peripheral surface of the cylindrical portion 46b of the large diameter portion 33 (described later). The slanted inner surface 18b is arranged at a position to face the outer peripheral surface of the tapered portion 46a of the large diameter portion 33 (described later). When the connector 36 of the heater cartridge 30 is coupled to the electrical contact 21 of the handle 10 and the tapered portion 46a of the large diameter portion 33 abuts/contacts against the slanted inner surface 18b of the distal support 18, the position of the heater cartridge 30 relative to the handle 10 is determined. Further, because the large diameter portion 33 abuts/contacts against the distal support 18, the heater cartridge 30 is prevented from wobbling about the proximal support 19.

The heater cartridge 30 includes a first pipe 31, a second pipe 32, and a large diameter portion 33 positioned between the first pipe 31 and the second pipe 32 along the longitudinal direction of the heater cartridge 30. When the heater cartridge 30 is placed in the insertion hole 16, the first pipe 31 is positioned between the proximal support 19 and the distal support 18. A space is formed between the outer peripheral surface of the first pipe 31 and the inner peripheral surface of the handle 10 that forms the insertion hole 16, and the gas in the insertion hole 16 flows through this space.

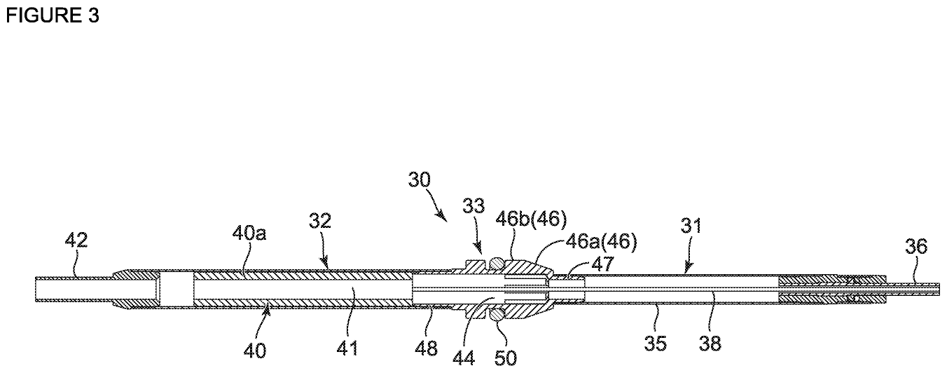

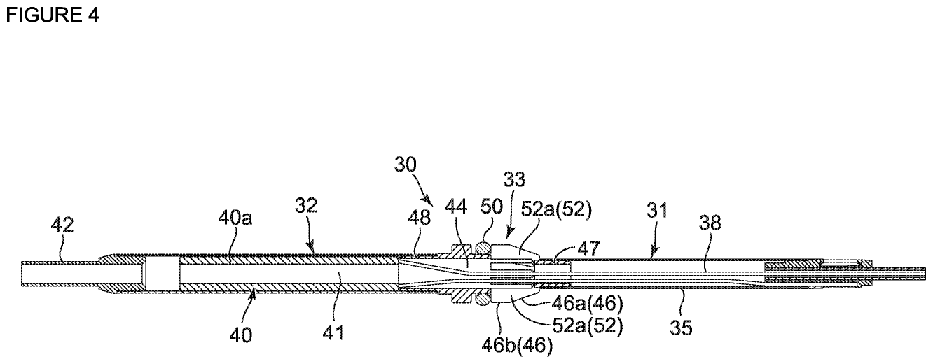

As shown in FIGS. 3 and 4, the first pipe 31 includes a pipe member 35 and a connector 36 placed at the end portion of the pipe member 35. By the connector 36 provided at the end portion of the pipe member 35, the end portion of the pipe member 35, that is, the end portion of the first pipe 31, is closed.

A wire 38 is connected to the connector 36, and the wire 38 is inserted through the internal space of the pipe member 35. The wire 38 extends through the connection-through space 44 of the large diameter portion 33 (described later), and extends to the heater 40 (described later) provided in the second pipe 32.

The second pipe 32 is comprised of a tubular member, and the heater 40 is housed inside the second pipe 32. In other words, the second pipe 32 has an inner space 41 that houses the heater 40. The heater 40 includes an insulator 40a formed in a tubular shape and a heater wire (not shown) placed in the insulator 40a. The insulator 40a is in close contact with the inner peripheral surface of the second pipe 32. The heater wire is connected to the wire 38 extending from the connector 36.

The heater 40 is placed at an intermediate position of the second pipe 32 in the longitudinal direction of the heater cartridge 30. The portion of the second pipe 32 positioned closer to the front side than the heater 40 functions as the nozzle 42, which allows to exhaust gas heated by the heater 40. The nozzle 42, that is, the front end of the second pipe 32, is open to enable the outflow of gas.

As shown in FIGS. 3 and 4, the opening of the second pipe 32 at the front end may have an internal diameter smaller than that of the insulator 40a, but is not limited thereto. The internal diameter of the opening of the second pipe 32 at the front end may be equal to, or larger than, the internal diameter of the insulator 40a.

The large diameter portion 33 has an external shape larger in diameter than both the outer diameter of the first pipe 31 and the outer diameter of the second pipe 32. The large diameter portion 33 fits to the distal support 18 of the handle 10. Even in this state, the maximum outer diameter of the large diameter portion 33 is larger than the outer diameter of the first pipe 31, so as a gap is formed between the first pipe 31 and the inner peripheral surface of the insertion hole 16. Additionally, since the outer diameter of the second pipe 32 is smaller than the maximum outer diameter of the large diameter portion 33, when the heater cartridge 30 is fitted into the handle 10, the outer diameter of the second pipe 32 at the front end side of the hot air device 11 is made small. Accordingly, even during operations using a microscope, it is possible to prevent the second pipe 32 from obstructing the work.

The large diameter portion 33 has a tubular shape. That is, the large diameter portion 33 is comprised of a tubular metal fitting. The internal space of the large diameter portion 33 will hereinafter be referred to as the connection-through space 44. The large diameter portion 33 includes a body 46, a first holding portion 47 extending from the body 46 in the first direction (to the right in FIG. 3), and a second holding portion 48 extending from the body 46 in the second direction, which is opposite to the first direction (to the left in FIG. 3).

The body 46 includes a tapered portion 46a having a tapered outer peripheral surface, and a cylindrical portion 46b adjacent to the tapered portion 46a, having a cylindrical outer peripheral surface. When the connector 36 of the heater cartridge 30 is coupled to the electrical contact 21 of the handle 10, the outer peripheral surface of the tapered portion 46a abuts/contacts against the slanted inner surface 18b (see FIG. 2) of the distal support 18 of the handle 10. Thus, the positioning of the heater cartridge 30 in the longitudinal direction of the handle 10 is determined. Additionally, since the introduction passage 52 has an axially elongated shape that opens at least at the outer surface of the tapered portion 46a, it is possible to ensure a larger opening area at the outer edge of the introduction passage 52 when the tapered portion 46a is abutting to the slanted inner surface 18b, and may reduce the gas inflow resistance.

An O-ring 50 (sealing member) is installed on the cylindrical portion 46b. The O-ring 50 is fitted into a recess formed on the outer peripheral surface of the cylindrical portion 46b. The O-ring 50 will be in close contact to the parallel inner surface 18a of the distal support 18. By the O-ring 50 abutting against the parallel inner surface 18a of the distal support 18, the gas flowing through the insertion hole 16 may be prevented from going away through the distal portion 10b of the handle. The O-ring 50 may be omitted, so the outer peripheral surface of the cylindrical portion 46b will abut to the parallel inner surface 18a of the distal support 18.

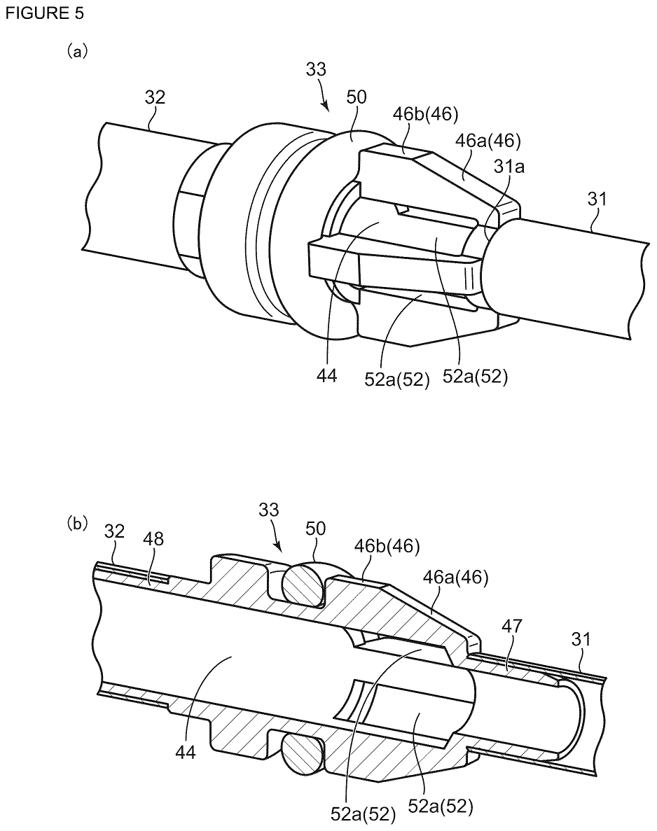

The first holding portion 47 is provided at the end portion of the first pipe 31 side of the body 46, that is, at the outer edge of the tapered portion 46a. The first holding portion 47 is integrally formed with the body 46. As shown in FIG. 5(b), the first holding portion 47 is formed in a tubular shape, and the first pipe 31 is fitted externally onto the first holding portion 47. As shown in FIG. 5(a), when the end portion 31a of the first pipe 31 abuts against the outer edge of the body, specifically the outer edge of the tapered portion 46a, the position of the first pipe 31 relative to the body 46 is determined. In this state, the first pipe 31 is held by the first holding portion 47.

The inner peripheral surface of the first holding portion 47 and the inner peripheral surface of the tapered portion 46a may be connected in a flush condition, or may be connected in a stepped manner. In addition, the shape of the first holding portion 47 is not limited to a shape that extends from the body 46. For example, the first holding portion 47 may be configured by an annular recess formed along the inner peripheral surface of the tapered portion 46a within a predetermined distance from the outer edge of the tapered portion 46a. Even in such a case, the first holding portion 47 is integrally formed with the body 46. In this configuration, the first pipe 31 is retained by the first holding portion 47 by inserting into the first holding portion 47.

The second holding portion 48 is provided at the end portion of the second pipe 32 side of the body 46, that is, at the outer edge of the cylindrical portion 46b. The second holding portion 48 is integrally formed with the body 46. The second holding portion 48 is formed in a tubular shape, and by the second pipe 32 fitting externally onto the second holding portion 48, the second pipe 32 is retained by the second holding portion 48. Accordingly, the large diameter portion 33 also functions to connect the first pipe 31 and the second pipe 32.

The inner peripheral surface of the second holding portion 48 and the inner peripheral surface of the cylindrical portion 46b may be connected in a flush condition, or may be connected in a stepped manner. In addition, the shape of the second holding portion 48 is not limited to a shape that extends in a tubular form. For example, the second holding portion 48 may be configured by an annular recess formed along the inner peripheral surface of the cylindrical portion 46b, within a predetermined distance from the outer edge of the cylindrical portion 46b. Even in such a case, the second holding portion 48 is integrally formed with the body 46. In this configuration, the second pipe 32 is retained by the second holding portion 48 by inserting into the second holding portion 48.

The connection-through space 44 is formed by the inner peripheral surface of the first holding portion 47, the inner peripheral surface of the tapered portion 46a, the inner peripheral surface of the cylindrical portion 46b, and the inner peripheral surface of the second holding portion 48. The connection-through space 44 communicates with the inner space 41 of the second pipe 32, that is, with the space within the heater 40 (the space inside the insulator 40a).

As shown in FIG. 5(a) and 5(b), an introduction passage 52, which provides mutual communication between the outside of the large diameter portion 33 and the connection-through space 44, is formed on the body 46 of the large diameter portion 33. The introduction passage 52 includes a plurality of flow paths 52a, which are placed in intervals in the circumferential direction of the large diameter portion 33. Each flow path 52a penetrates the large diameter portion 33 between the outer surface of the large diameter portion 33 and the inner peripheral surface of the large diameter portion 33, that defines the connection-through space 44. Accordingly, the gas supplied to the insertion hole 16 may flow into the connection-through space 44 via the introduction passage 52 (the plurality of flow paths 52a).

The outer edge of each flow path 52a (introduction passage 52) is opened on the outer surface of the body 46 (large diameter portion 33) in the range from the tapered portion 46a to the cylindrical portion 46b. The outer edge of this flow path 52a (introduction passage 52) serves as the end portion on the gas inlet side of the introduction passage 52. The inner edge of each flow path 52a (introduction passage 52) is opened to the inner peripheral surface (the inner peripheral surface facing the connection-through space 44) of the body 46 (large diameter portion 33) in the range from the tapered portion 46a to the cylindrical portion 46b. The inner edge of this flow path 52a (introduction passage 52) serves as the end portion on the gas outlet side of the introduction passage 52. Accordingly, both the outer edge and inner edge of each flow path 52a (introduction passage 52) are formed in a shape that is elongated in the longitudinal direction of the heater cartridge 30. Therefore, it may increase the opening area of the introduction passage 52.

Further, the inner edge of each flow path 52a (introduction passage 52) is positioned between the first holding portion 47 and the second holding portion 48 in the longitudinal direction of the heater cartridge 30. Accordingly, the inner edge of each flow path 52a (introduction passage 52) is not obstructed by the first pipe 31 or the second pipe 32.

The body 46 is formed in a tubular shape, and the thickness of the body 46 is greater than the thickness of the first pipe 31. The thickness of the body 46 is defined by the inner peripheral surface of the body 46 facing the connection-through space 44 and the outer surface of the body 46 exposed to the outside of the heater cartridge 30. The thickness of the first pipe 31 is defined by the inner and outer surfaces of the pipe member 35. Since the thickness of the metal fitting forming the body 46 is greater than the thickness of the pipe member 35 forming the first pipe 31, the strength of the body 46 where the introduction passage 52 is formed is ensured. Therefore, even if the opening area of the introduction passage 52 is enlarged, it may prevent the deterioration in the attachability/detachability of the heater cartridge to and from the handle.

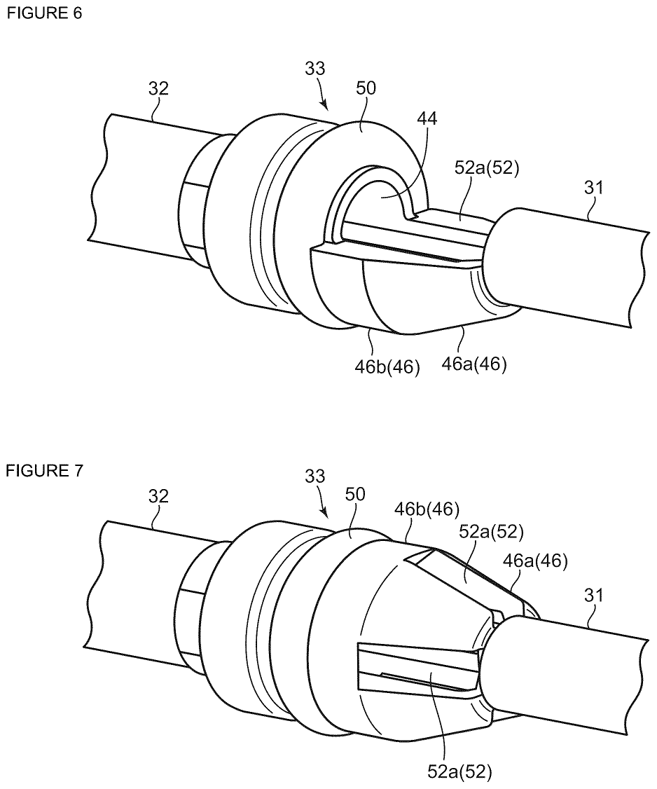

In the example shown in FIG. 5(a), the number of flow paths in the circumferential direction of the large diameter portion 33 is four, but the number of flow paths is not limited to thereto. The flow path 52a may be provided as only one around the circumferential direction of the large diameter portion 33, or two or more may be provided. For example, FIG. 6 illustrates an example of the body 46 of the large diameter portion 33 in a split-half shape, and the introduction passage 52 configured with a single flow path 52a.

Additionally, in the example of FIG. 5(a), the introduction passage 52 (each flow path 52a) is formed in a range from the tapered portion 46a to the cylindrical portion 46b, but it is not limited thereto. For example, as shown in FIG. 7, the outer edge of the introduction passage 52 (each flow path 52a) may be sized so it opens only within the range of the tapered portion 46a.

Here, the operation of the heater cartridge 30 will be described. The heater cartridge 30 is inserted into the insertion hole 16 of the handle 10 from the connector 36 side. At this time, the heater cartridge 30 is inserted to the insertion hole 16 until the connector 36 is coupled with the electrical contact 21 inside the handle 10. The position of the heater cartridge 30 relative to the handle 10 is determined by the tapered portion 46a of the large diameter portion 33 of the heater cartridge 30 abutting the slanted inner surface 18b of the distal support 18 inside the handle 10. In this state, a space is formed between the heater cartridge 30 and the inner peripheral surface of the insertion hole 16. Further, the connector 36 of the heater cartridge 30 is electrically connected to the electrical contact 21 of the handle 10.

When the controller (not shown) is activated in this state, power is supplied to the heater cartridge 30, to the heater 40 in the second pipe 32 via the electric wire 38 arranged from the connector 36 of the first pipe 31, through the connection-through space 44 of the large diameter portion 33, and towards the second pipe 32. Additionally, gas is supplied from the controller into the handle 10, the gas flowing through the cord 13, entering the flow-through hole 15 of the handle 10, and further through the flow-through space 20 of the proximal support 19, then to the insertion hole 16. The gas flowing through the insertion hole 16 enters the introduction passage 52 (each flow path 52a) of the large diameter portion 33 and reaches the connection-through space 44 within the large diameter portion 33. Further, the gas flows from the connection-through space 44 into the inner space 41 of the second pipe 32, then through the heater 40. As a result, the gas is heated by the heater 40, and subsequently, blows out from the heater cartridge 30 through the front end of the second pipe 32 (nozzle 42).

As described above, in the heater cartridge 30 of the present embodiment, when gas is supplied to the handle 10 while the heater cartridge 30 is inserted into the insertion hole 16 of the handle 10, the gas is introduced from the insertion hole 16 through the introduction passage 52 formed on the large diameter portion 33 of the heater cartridge 30 into the connection-through space 44 of the large diameter portion 33. The gas then flows into the inner space 41 of the second pipe 32, where it is heated by the heater 40. The heated gas flows out from the second pipe 32 through the opening at the front end of the second pipe 32. The introduction passage 52, which allows gas to flow from the insertion hole 16 of the handle 10 into the connection-through space 44, is provided on the large diameter portion 33, which has an external shape larger than the outer diameters of both the first pipe 31 and the second pipe 32. Accordingly, it may suppress the increase in gas inflow resistance. That is, if an opening for gas inflow is formed on the first pipe 31 having the connector 36, and when the first pipe 31 is made with a small diameter, the opening will become small, resulting in an increase in gas inflow resistance. On the other hand, when the introduction passage 52 is formed at the large diameter portion 33, the opening area of the introduction passage 52 may be increased, thereby suppressing increase in gas inflow resistance. Moreover, because the introduction passage 52 is provided on the large diameter portion 33, it may prevent strength deterioration of the first pipe 31, which in turn avoids deterioration of the attachability/detachability of the heater cartridge 30 from the handle 10.

Further in the present embodiment, since the large diameter portion 33 includes a body 46, a first holding portion 47, and a second holding portion 48, it may stably hold the first pipe 31 and the second pipe 32.

Further in the present embodiment, the introduction passage 52 is open at the inner peripheral surface of the large diameter portion 33 between the first holding portion 47 and the second holding portion 48. Accordingly, it may stably hold the first pipe 31 and the second pipe 32 while preventing the first pipe 31 and the second pipe 32 from obstructing the gas inflow into the connection-through space 44.

Further in the present embodiment, since the introduction passage 52 penetrates the large diameter portion 33 so as to open on the inner peripheral surface of the large diameter portion 33 facing the connection-through space 44, the gas may flow smoothly into the connection-through space 44 of the large diameter portion 33.

Further in the present embodiment, the introduction passage 52 includes multiple flow paths 52a placed at intervals from one another in the circumferential direction of the large diameter portion 33. Accordingly, it may increase the opening area of the introduction passage 52 while maintaining the strength of the large diameter portion 33.

Further in the hot air device 11 of the present embodiment, because the heater cartridge 30 is supported by the handle 10 via the proximal support 19 and the distal support 18, which are placed away from each other, the heater cartridge 30 may be stably supported by the handle 10.

Further in the hot air device 11 of the present embodiment, because the portion of the large diameter portion 33 that contacts the handle 10 is tapered, it is easier to position the large diameter portion 33 relative to the handle 10 in the longitudinal direction of the handle 10.

Further in the hot air device 11 of the present embodiment, the large diameter portion 33 not only functions as a portion for forming the introduction passage 52, but also serves as a portion for positioning the heater cartridge 30 along the longitudinal direction relative to the handle 10.

### Second Embodiment

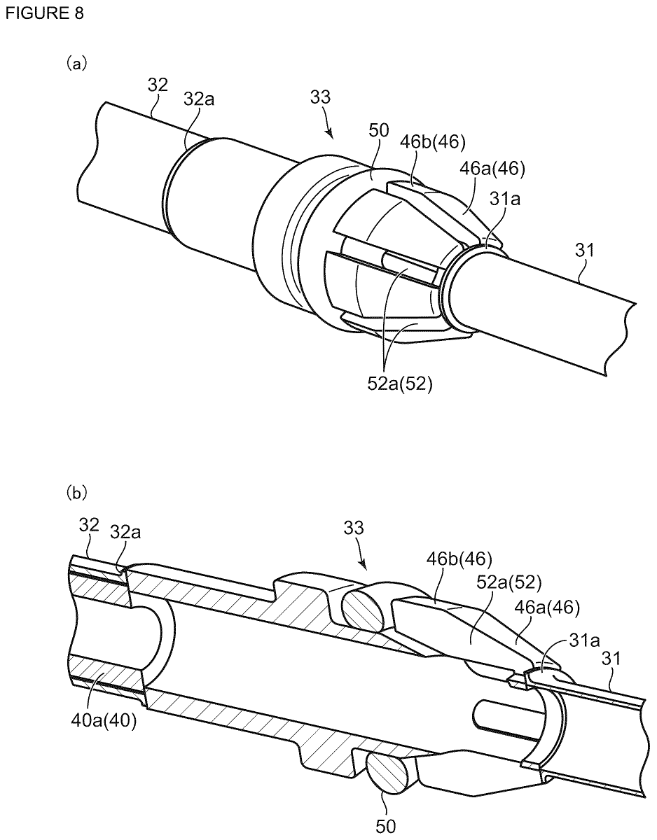

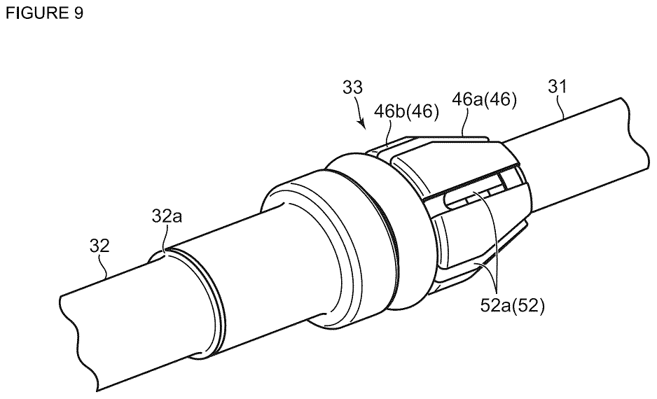

In the first embodiment, the large diameter portion 33 includes a first holding portion 47 and a second holding portion 48, however, at least one of the first holding portion 47 and the second holding portion 48 may be omitted. In the second embodiment, as shown in FIG. 8 (a), (b) and FIG. 9, the first holding portion 47 and the second holding portion 48 are omitted. Here, the same reference numerals are assigned to components identical to those in the first embodiment, and detailed explanations thereof are omitted.

As shown in FIG. 8 (a) and (b), the end portion 31a of the first pipe 31 is either flared or provided with a flange, and the flared end portion 31a or the flange is welded to the end portion of the large diameter portion 33. In other words, the first pipe 31 is held by the body 46 of the large diameter portion 33.

Further, as shown in FIG. 9 and FIG. 8(b), the end portion 32a of the second pipe 32 is either flared or provided with a flange, and the flared end portion 32a or the flange is welded to the end portion of the large diameter portion 33. In other words, the second pipe 32 is hold by the body 46 of the large diameter portion 33.

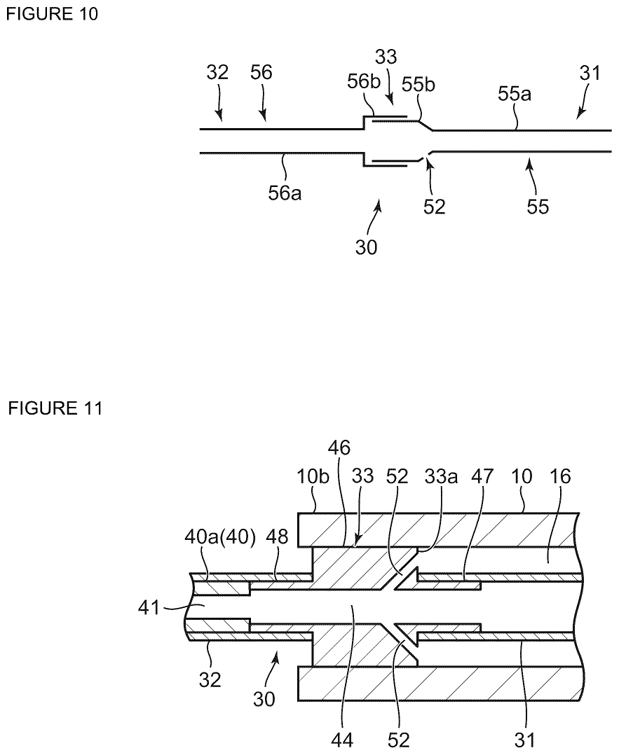

Alternatively, as shown in FIG. 10, the heater cartridge 30 may be formed by welding two pipe materials 55 and 56 together. One of the pipe materials 55, includes a first pipe portion 55a configuring the first pipe 31, and a first enlarged diameter portion 55b formed at the end portion of the first pipe portion 55a. The other pipe material 56, includes a second pipe portion 56a configuring the second pipe 32, and a second enlarged diameter portion 56b formed at the end portion of the second pipe portion 56a. The large diameter portion 33 is formed by the first enlarged diameter portion 55b and the second enlarged diameter portion 56b. The first enlarged diameter portion 55b is integrally formed at the end portion of one of the pipe materials 55 by processing to expand the end portion of the pipe material 55. The second enlarged diameter portion 56b is integrally formed at the end portion of the other pipe material 56 by processing to expand the end portion of the pipe material 56. Subsequently, the first enlarged diameter portion 55b and the second enlarged diameter portion 56b are welded together in the state overlapped with each other. After welding, the introduction passage 52 is formed by a drilling process, thereby forming the large diameter portion 33 integrally with the first pipe 31 and the second pipe 32. The portion configured by the first enlarged diameter portion 55b at least includes the tapered portion 46a. The portion configured by the second enlarged diameter portion 56b includes the cylindrical portion 46b.

Additionally, although not shown in the drawings, the first pipe 31, the large diameter portion 33, and the second pipe 32 may be integrally formed by processing a single pipe material. In this case, the large diameter portion 33 is formed on the pipe material by performing an expanding process on the intermediate section of the pipe material. By forming a hole on the expanded diameter portion by a drilling process, the large diameter portion 33 is formed.

Although the configuration, operation, and effects other than those described have been omitted, it should be understood that the description of the first embodiment may also be applied to the second embodiment.

### Other Embodiments

It should also be understood that the embodiments disclosed herein are merely exemplary in all respects and are not intended to limit. The present invention is not limited to the embodiments described above, and various modifications and improvements are possible without departing from the scope and spirit of the invention.

For example, in the embodiment described above, the outer edge of the introduction passage 52 is opened on the outer peripheral surface of the body 46 (large diameter portion 33) in the range from the tapered portion 46a to the cylindrical portion 46b, but is not limited thereto. For example, as shown in FIG. 11, the outer edge of the introduction passage 52 may be opened not on the outer peripheral surface of the body 46 of the large diameter portion 33, but on the side face 33a of the large diameter portion 33 facing the first pipe 31. Even in this case, the inner edge of the introduction passage 52 opens to the inner peripheral surface (inner peripheral surface facing the connection-through space 44) of the body 46 (large diameter portion 33).

### DESCRIPTION OF REFERENCE SYMBOLS

10: handle
11: hot air device
16: insertion hole
18: distal support
19: proximal support
21: electrical contact
30: heater cartridge
31: first pipe
32: second pipe
33: large diameter portion
36: connector
40: heater
41: inner space
44: connection-through space
46: body
46a: tapered portion
46b: cylindrical portion
47: first holding portion
48: second holding portion
52: introduction passage
52a: flow path

1. A heater cartridge, said heater cartridge configured to be inserted to an insertion hole provided in a handle, comprising
a first pipe having a connector configured to be coupled to an electrical contact provided in said handle,
a heater electrically connected to said connector,
a second pipe having an inner space for housing said heater and a front end which is opened, and
a large diameter portion positioned between said first pipe and said second pipe, said large diameter portion having an external shape with diameter larger than the outer diameter of said first pipe and the outer diameter of said second pipe,
said large diameter portion is formed with a connection-through space communicating with said inner space of said second pipe, and with an introduction passage mutually communicating with the outside of said large diameter portion and said connection-through space, wherein when in a state said heater cartridge is placed in said insertion hole, said heater cartridge is configured to have gas inflow from said insertion hole to said connection-through space via said introduction passage.

2. The heater cartridge according to claim 1, wherein
said large diameter portion comprising a body formed with said introduction passage, a first holding portion integrally formed with said body for holding said first pipe, and a second holding portion integrally formed with said body for holding said second pipe.

3. The heater cartridge according to claim 2, wherein
said introduction passage is open to an inner peripheral surface facing said connection-through space, between said first holding portion and said second holding portion.

4. The heater cartridge according to claim 1, wherein
said introduction passage is penetrated through said large diameter portion between an outer surface of said large diameter portion and an inner peripheral surface facing said connection-through space.

5. The heater cartridge according to claim 4, wherein
said introduction passage comprising multiple flow paths placed at intervals from one another in a circumferential direction of said large diameter portion.

6. The heater cartridge according to claim 1, wherein
said introduction passage is provided at a tubular body of said large diameter portion positioned between said first pipe and said second pipe, and
the thickness of said body is greater than the thickness of said first pipe.

7. A hot air device comprising,
a heater cartridge according to claim 1,
a handle provided with an insertion hole to insert said heater cartridge, wherein
said handle is configured to support said connector of said heater cartridge inserted in said insertion hole, and support said large diameter portion at a position away from said connector.

8. The hot air device according to claim 7, wherein
said large diameter portion is tapered at a portion which contacts the handle.

9. A hot air device comprising,
a heater cartridge according to claim 1,
a handle provided with an insertion hole for receiving said heater cartridge, wherein
said large diameter portion contacts said handle at a portion besides said introduction passage.
